(19) United States
(12) Patent Application Publication
(10) Pub. No.: US 2017/0039204 A1
(43) Pub. Date: Feb. 9, 2017

(54) SETTING EXPIRATION OF SOCIAL MEDIA POSTS

(71) Applicant: Longsand Limited, Cambridge (GB)

(72) Inventors: Sean Blanchflower, Cambridge (GB); Abigail Betley, London (GB)

(21) Appl. No.: 15/303,100

(22) PCT Filed: Apr. 25, 2014
(86) PCT No.: PCT/EP2014/058528

§ 371 Date: Oct. 10, 2016

(51) Int. Cl. G06F 17/30; H04L 12/58

(52) U.S. Cl. CPC G06F 17/30085; G06F 17/30598; G06F 17/30303; H04L 51/34; H04L 51/32

(57) ABSTRACT

Methods, apparatus, systems and articles of manufacture are disclosed for expiration of social media posts. An example method includes analyzing a social media post on a social media profile, determining a characteristic of the social media post, and setting an expiration time at which the social media post is to be removed from the social network interface based on the characteristic.

### BACKGROUND

Social media has enabled people around the world to communicate and stay in touch in many ways. Using social media, individuals can share their thoughts, opinions, experiences, etc. to others having access their account. In some instances, privacy settings enable a user of a social network to set a degree of access to his or her social media profile from personally authorized users to all users of the social network.

Individuals may register an account with a social network to join the social network. Using the registered account, a user or subscriber may then communicate with other users via corresponding registered accounts by posting messages and/or media (e.g., an article, a picture, a video, an audio clip, etc.) to other accounts and/or the subscriber's own account. In many instances, registered user accounts and corresponding user profiles are stored, managed, and/or maintained via a network of servers. The network of servers may be maintained by a social network entity (e.g., Facebook®, Twitter®, Instagram®, etc.). Social media users or subscribers may access their accounts or other accounts via a network, typically the Internet.

Various types of communications may occur via social networks to enable subscribers, users, entities, etc. to spread information through the network. Such communications include text, audio, video, images, etc. In many instances, these communications are accessible to third parties that are neither the sender nor the receiver of the communication.

### BRIEF DESCRIPTION OF THE DRAWINGS

FIG. 1A illustrates an example social network system including a user device having an expiration monitor constructed in accordance with the teachings of this disclosure.

FIG. 1B illustrates an example social network system including a social network server having an expiration monitor constructed in accordance with the teachings of this disclosure.

FIG. 2 is a block diagram of an example expiration monitor that may be used to implement the expiration monitor of FIG. 1.

FIG. 3 is a block diagram of another example expiration monitor that may be used to implement the expiration monitor of FIG. 1.

FIG. 4 is an example expiration time table that may be managed and/or utilized by the example expiration monitors of FIGS. 2 and/or 3.

FIG. 5 is a flowchart representative of example machine readable instructions that may be executed to implement the expiration monitor of FIGS. 2 and/or 3.

FIG. 6 is another flowchart representative of example machine readable instructions that may be executed to implement the expiration monitor of FIGS. 2 and/or 3.

FIG. 7 is a flowchart representative of example machine readable instructions that may be executed to implement the expiration monitors of FIG. 2 and/or 3 to adjust expiration time(s) based on user feedback.

FIG. 8 is an example block diagram of a processor platform capable of executing the instructions of FIGS. 5, 6, and/or 7 to implement the expiration monitors of FIGS. 2 and/or 3.

### DETAILED DESCRIPTION

Interactions on social media may compromise a degree of privacy for social media users. For example, social media posts to a subscriber's social media profile and/or user account may include information that the subscriber does not wish to convey or publish to his or her family, peers, associates, etc. for indefinite periods of time. With the increasing popularity of social media and the variety of social networks, it may become a task for a subscriber to manage his or her social network profiles. In some instances, it may be days or weeks between times when a subscriber accesses his or her account and more so his or her past social media posts. In some instances, social media posts to a user's social media profile or account may go unnoticed by a user or be forgotten by the user. Examples disclosed herein involve analyzing social media posts to determine appropriate expiration times for the social media posts based on at least content of the social media posts and/or characteristics of the social media posts.

In some examples, when users post messages and/or media to their accounts or other user accounts, the messages and/or the media are stored on servers managed by a social network entity. In many instances, the messages and/or the media are accessible until the messages and/or the media are deleted by any of the users having access to them or by the social network entity.

An example method disclosed herein involves analyzing a social media post on a social media profile, determining a characteristic of the social media post, and setting an expiration time at which the social media post is to be removed from the social network interface based on the characteristic. Some examples herein involve monitoring a user account or a social media profile associated with a social media post, and setting an expiration time based on settings of the user account and/or social media profile.

Examples disclosed herein involve analyzing a social media post on a social media profile, classifying the social media post into a classification category, and setting an expiration time for the social media post based on the classification category. Examples disclosed herein involve monitoring a social media profile of a user, detecting a social media post in the social media profile, analyzing content of the social media post, and setting an expiration time for the social media post based on the content.

As used herein, a social media post is any message, image, video, audio, comment, status, etc. that is associated with (e.g., uploaded to, added to, written to, attached to, etc.) a social media profile of a social network. As used herein a social media profile is an interface (e.g., a web page, such as a Facebook® page, a Twitter® page, etc.) that enables and/or provides access to information of a registered account (e.g., a user account, an entity account, a group account, etc.) of the social network. As used herein, an expiration time associated with a social media post is a time at which the social media post is no longer accessible from a social network profile. In other words, at the expiration time (or after an expiration time period), the social media profile is deleted from the social media profile (e.g., the data of the social media post is erased from a social network server and/or user device maintaining the social media profile). As used herein, the terms subscriber and user may be used interchangeably to refer to an individual using or accessing an expiration monitor, a social network, and/or a social network profile, though a subscriber is understood to be an individual with a registered account of the social network.

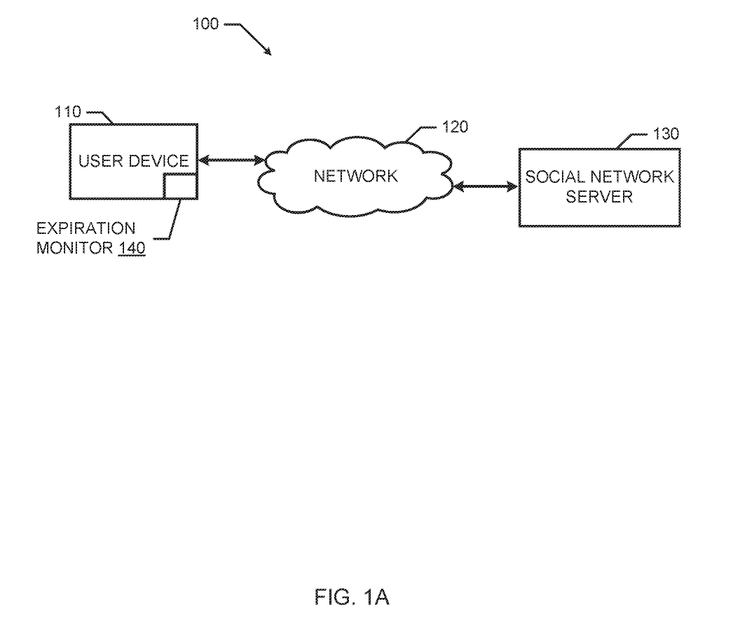

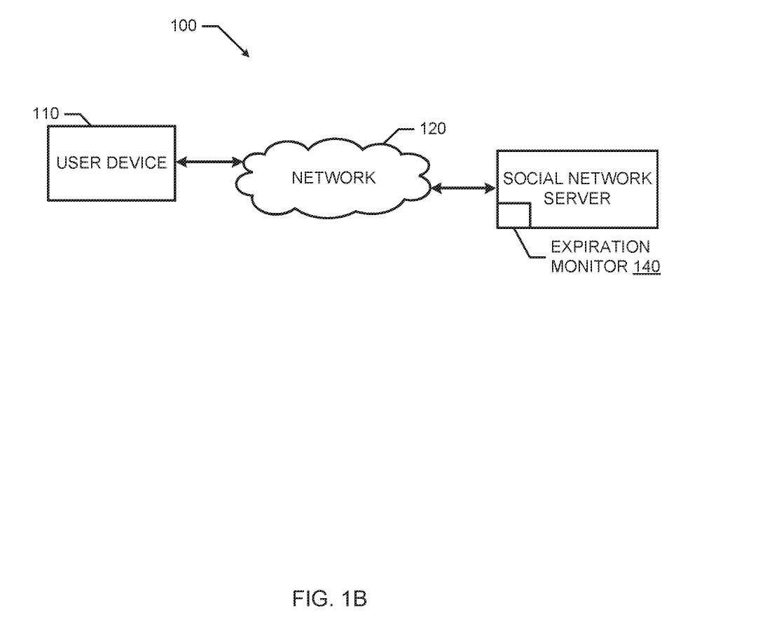

FIGS. 1A and 1B illustrate an example social network system 100. The social network 100 of FIGS. 1A and 1B include an example user device 110, an example network 120, and an example social network server 130. The user device 110 of FIGS. 1A and 1B may be implemented by at least one of a personal computer, a laptop computer, a tablet computer, a smartphone, telephone, a personal digital assistant, a game console, or any other electronic device. The network 120 of FIGS. 1A and 1B may be the Internet, a local area network (LAN), an intranet, or any other network. The social network server 130 FIGS. 1A and 1B may be any type of server and may be comprised of a plurality of servers.

In the illustrated example of FIG. 1A, the user device 110 includes example expiration monitor 140 constructed in accordance with the teachings of this disclosure. In the illustrated example of FIG. 1B, the social network server 130 includes the expiration monitor 140 constructed in accordance with the teachings of this disclosure. The expiration monitor 140 of FIGS. 1A and/or 1B monitors social media profile(s) and/or social media posts and assigns an appropriate expiration time to the social media posts. As disclosed herein, the expiration monitor 140 of FIGS. 1A and/or 1B may be located partially or entirely in the user device 110 and/or the social network server 130. For example, the expiration monitor 140 may be an application that is downloaded to the user device 110 in FIG. 1A and/or an application that is used to manage and maintain the social network server 130 in FIG. 1B. In some examples, the expiration monitor 140 may be located on a device other than the user device 110 or the social network server 130 of FIGS. 1A or 1B (e.g., a device in communication with the network 120). As disclosed herein, it is understood that the purposes of the expiration monitor 140 may be fulfilled regardless of the location of the expiration monitor 140 within the social network system 100.

In the illustrated example of FIGS. 1A or 1B, a subscriber (e.g., a social network consumer) and/or user may use the user device 110 to register and/or access an account of a social network associated with the social network server 130 via the network 120. The example social network server 130, stores, manages, and/or maintains account information of subscribers of the social network. In some examples, the user device 110 may additionally or alternatively store, manage, and/or maintain account information of a user associated with the user device. The expiration monitor 140, as disclosed herein, monitors the accounts of the social media network to identify posts and/or manage expiration times of posts added to corresponding social media profiles of the accounts.

In the illustrated examples of FIGS. 1A and/or 1B, a user may use the user device 110 to upload a social media post (e.g., post a status, comment on another post, post an image, post a video, post audio, etc.) to a social media profile managed by the social network server 130. In such examples, the social network server 130 stores data (e.g., text data, image data, video data, metadata, etc.) for the social media post. In some examples, the user device 110 may additionally and/or alternatively store data and/or information corresponding to the social media post.

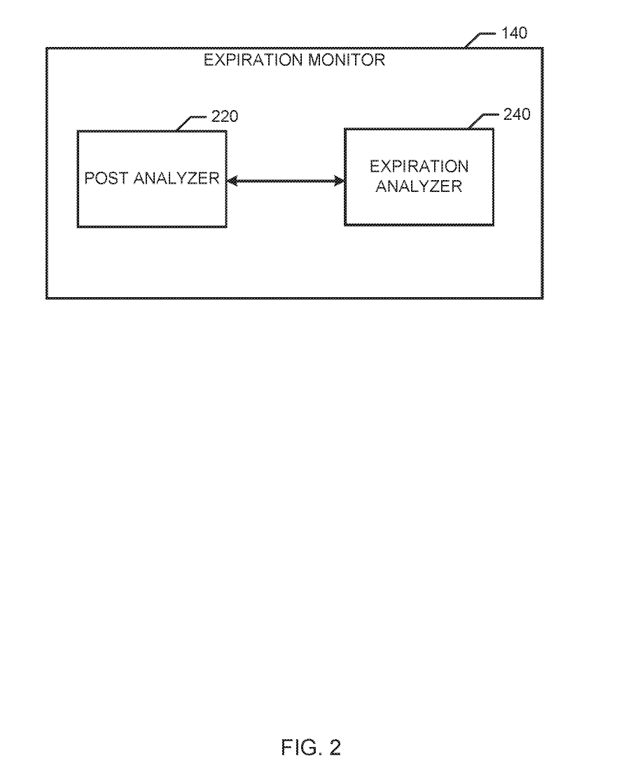

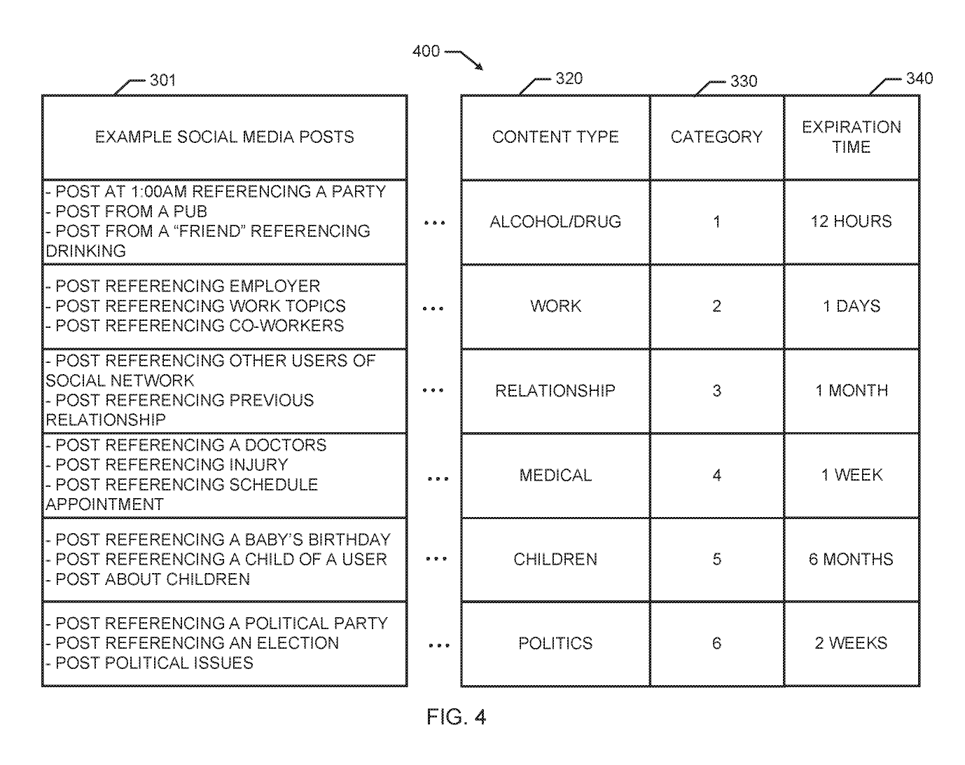

The example expiration monitor 140 of FIGS. 1A and/or 1B, as further disclosed below in connection with FIGS. 2 and/or 3, monitors the social media profile to detect when social media posts are uploaded to the social media profile. When the expiration monitor 140 detects that a social media post has been uploaded, the expiration monitor 140 analyzes the social media post and determines an appropriate expiration time for the social media post. For example, the expiration monitor 140 may classify the social media post into categories having corresponding expiration times and/or time periods (see FIG. 4). In some examples, the expiration monitor 140 may determine that no expiration time is to be assigned to the social media post or that the social media post is to expire immediately (i.e., an expiration time period of zero or near zero time).

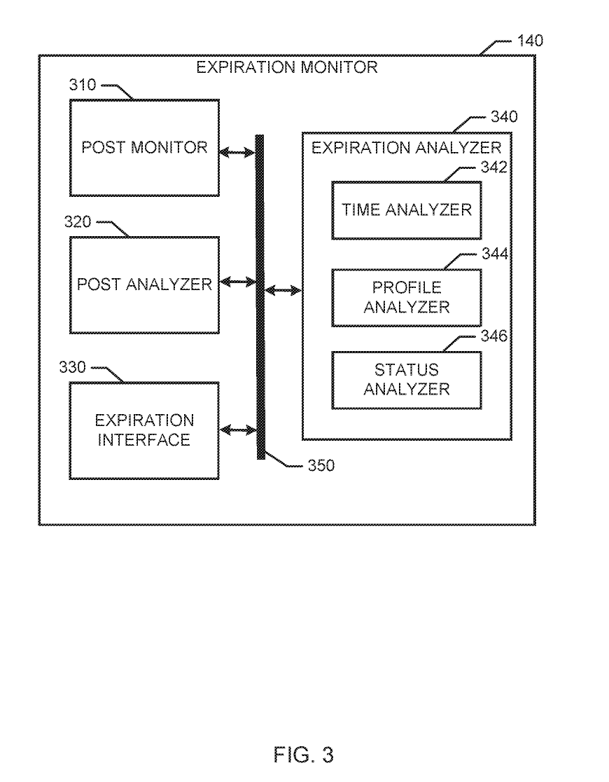

FIGS. 2 and 3 are block diagrams of an example expiration monitor 140. The expiration monitor 140 of FIGS. 2 and/or 3 may be used to implement the expiration monitor 140 in the illustrated examples of FIGS. 1A and/or 1B. The expiration monitor 140 of FIGS. 2 and/or 3, as disclosed herein, monitors a social media profile, analyzes social media posts, and/or determines expiration times for the social media posts uploaded to the social media profiles. The expiration monitor 140 of FIG. 2 includes a post analyzer 220 and an expiration analyzer 240.

The post analyzer 220 of FIG. 2 analyzes social media posts on a social media profile. The post analyzer 220 of FIGS. 2 may classify the social media posts into classification categories based on characteristics of the social media post. Such characteristics may include content, time, user association (e.g., who and/or what posted the social media post, who and/or what is “tagged” in the social media post, etc.). The example expiration analyzer 240 of FIG. 2 sets an expiration time for the social media posts analyzed by the social media analyzer 220. The expiration time set by the expiration analyzer 240 is a time at which the social media post is to be removed from the social media profile. Accordingly, after the expiration time, the social media post may no longer be accessible from the social media profile. The post analyzer 220 and the expiration analyzer 240 FIG. 2 are further described in more detail with reference to the post analyzer 320 and expiration analyzer 340 of FIG. 3. Accordingly, the post analyzer 220 and/or the expiration analyzer 240 of FIG. 2 may perform the same and/or similar functions as the post analyzer 320 and expiration analyzer 340, respectively, of FIG. 3, and thus may be referred to herein interchangeably to perform similar functions.

It is understood that the expiration monitor 140 of FIG. 3 may be used to implement the expiration monitor 140 of FIG. 2. The expiration monitor 140 in the illustrated example of FIG. 3 includes a post monitor 310, a post analyzer 320 (which may be used to implement the post analyzer 320 of FIG. 2), an expiration interface 330, and an expiration analyzer 340 (which may be used to implement the expiration analyzer 340 of FIG. 2). The example expiration analyzer 340 of the illustrated example of FIG. 3 includes a time analyzer 342, a profile analyzer 344, and a status analyzer 346. In the illustrated example of FIG. 3, an example communication bus 350 facilitates communication between the post monitor 310, the post analyzer 320, the expiration interface 330, and/or the expiration analyzer 340.

The example post monitor 310 of FIG. 3 monitors a social media profile (or many social media profiles) for social media posts. For example, a user may instruct the expiration monitor 140 to monitor a designated social media profile or user account. Accordingly, the post monitor 310 detects when social media posts are uploaded, added, etc. to a social media profile. In some examples, the post monitor 310 monitors the user device 110 to determine that a user has uploaded a social media post to the designated social media profile. Additionally or alternatively, the post monitor 310 may detect notifications (e.g., from the social network server 130) to the user device 110 indicating that a social media post has been uploaded to the designated social media profile. In some examples, the post monitor 310 may monitor the social network server 130 to detect user account activity associated with social media profile. For example, the post monitor 310 may detect when a user adds a social media post to the designated social media profile (e.g., based on data being uploaded to the server, the account being accessed by a subscriber associated with the account, or the account being accessed by other users of the social network). In some examples, the post monitor 310 retrieves data (e.g., text, image, video, audio, metadata, hyperlinks, etc.) associated with the detected social media posts. For example, the post monitor 310 may retrieve the data from the social network server 130 and/or the user device 110. In some examples, the post monitor 310 may determine the source of the detected social media post. For example, the monitor 310 may determine that the social media post was posted by a designated subscriber of the social media profile, an associated subscriber of the social media profile (e.g., a “friend” on Facebook®, a “follower” on Twitter® etc.), or other entity (e.g., an advertisement entity, third party requester, etc.).

The example post analyzer 320 of FIG. 3 analyzes the social media posts detected by the post monitor 310. In some examples, the post monitor 310 provides the post analyzer 320 with the data of the social media posts. Alternatively, the post analyzer 320 may retrieve the data of the social media post. The post analyzer 320 analyzes the social media post to identify content and/or determine a content type of the social media post to classify the social media post into a category. For example, the post analyzer 320 may analyze text data using any suitable classification techniques (e.g., keyword identification, sentiment analysis, etc.). As another example, the post analyzer 320 may perform image processing to identify a type of image that is posted to the social media profile. As yet another example, the post analyzer 320 may process video or audio from the social media post to detect content and/or content type. The example post analyzer 320 may detect metadata or other information corresponding to data in the social media post (e.g., age appropriate ratings, date information, display information, format, watermarks, digital signatures, etc.). The example post analyzer 320 may be able to analyze social media posts for malicious activity or content. In some examples, the post analyzer 320 may analyze hyperlinks in a social media post to determine content of a destination of the hyperlinks. By analyzing the content of the social media post, the post analyzer 320 is able to classify the social media post into a classification category using any suitable technique (e.g., Naive Bayes, frequency classifications, feature vectors, linear classifications, etc.).

The example post analyzer 320 of FIG. 3 is configured to analyze and classify the social media posts into at least one classification category. Accordingly, the post analyzer 320 may identify phrases and/or keywords in text of social media posts (or captions of social media posts) to determine the classification category. For example, “love” may trigger a relationship category, while “party” may trigger an alcohol/drug category. Furthermore, the post analyzer 320 may process images or other media of social media posts to determine classification categories. For example, the post analyzer 320 may identify a political poster in a social media post that triggers a politics category. A user may configure the post analyzer 320 to use any appropriate classification techniques to detect any number of classification categories via the expiration interface 330. After the post analyzer 320 analyzes the social media posts, the post analyzer 320 may provide the determined content and/or classification category to the expiration analyzer 340 to determine an appropriate expiration time based on the content and/or the classification category.

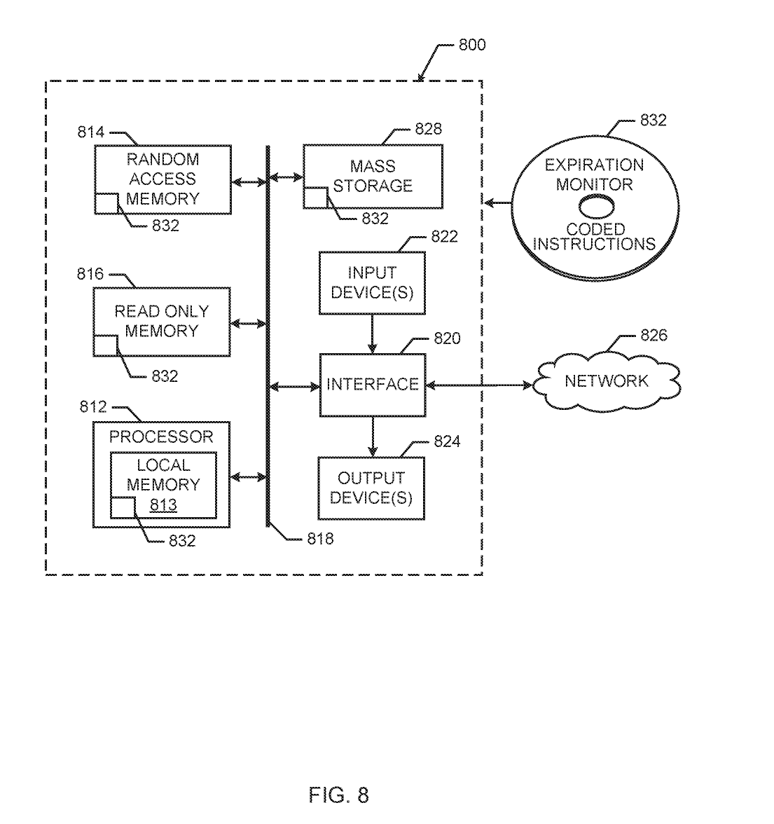

The expiration interface 330 of the illustrated example of FIG. 3 enables user access to the expiration monitor 140. The expiration interface 330 may be implemented via an interface circuit, input device(s), and/or output device(s) (e.g., see FIG. 8). In some examples, a user may access the expiration monitor 140 via the expiration interface 330 to control and/or adjust settings of the expiration monitor 140. For example, a user may manage and/or adjust classification settings of the post analyzer 320. In some examples, a user may adjust expiration times corresponding to certain classification settings (e.g., see FIG. 4) via the expiration interface 330. For example, a user may set rules for classification and/or expiration times. An example classification rule may be “if social media post references X, then classify as Y,” where is a keyword, image with a content type, etc. and Y is a classification category (e.g., social-related (alcohol/party), work-related, relationship related, etc.). An example expiration time rule may be “if X, then expiration time (or expiration time period) is Y,” where X is at least one condition and Y is a time at or time period after which the social media post is no longer accessible from the social media profile. Accordingly, the expiration interface 330 of FIG. 3 facilitates user control of the expiration monitor 140.

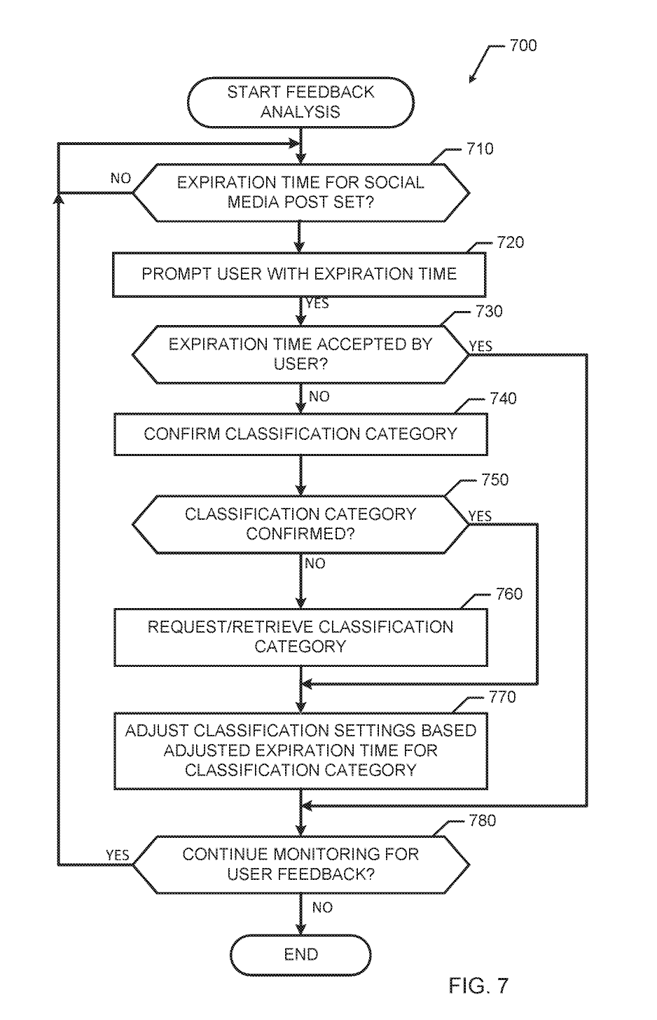

In some examples, the expiration monitor 140 may be used to provide and/or prompt a user regarding an expiration time that has been assigned to a social media post. For example, the expiration monitor 140 may prompt a user via the expiration interface 330 when an expiration time has been assigned to a social media post. In some examples, the expiration interface 330 may receive feedback from a user regarding an assigned expiration time. For example, if an assigned expiration time for a social media post is changed by a user or subscriber, the example expiration monitor may indicate such changes to the expiration analyzer 340, which may then use the feedback to adjust expiration time settings of the expiration monitor 140. An example feedback analysis is further described in connection with the flowchart of FIG. 7.

The expiration monitor 140 in the illustrated example of FIG. 3 determines an expiration time for social media posts detected by the post monitor 310 and/or analyzed by the post analyzer 320. In some examples, in addition to classification information received from the post analyzer 320, the expiration analyzer 340 considers other characteristics of a social media post and/or characteristics of a user account associated with a social media profile to determine an expiration time for the social media post. Accordingly, the expiration analyzer 340 of the illustrated example of FIG. 3 includes a time analyzer 342, a profile analyzer 344, and a status analyzer 346. In some examples, other types of analyzers may be included to analyze other characteristics of a social media profile and/or social media posts.

The expiration analyzer 340 may use the time analyzer 342 in FIG. 3 to determine a time associated with the social media post (e.g., when the social media post was uploaded to the social media profile). For example, the time analyzer 342 may detect a timestamp from data in the social media post (e.g. when a picture was taken, when a message was written, etc.) and identify the time of the social media post based on the timestamp. As a more specific example, the expiration monitor 140 may set expiration times based on when the social media post was posted to the social media profile and/or based on an identified timestamp. For example, social media posts uploaded between 9:00 PM and 5:00 AM may have a shorter expiration time period than social media posts posted between 12:00 PM and 5:00 PM. As another example, picture that was taken at 2:00 AM but posted at 3:00 PM may have an expiration time based on the timestamp time rather than the post time. An example user may choose to implement such expiration time settings to limit the exposure and/or accessibility of the social media posts uploaded during certain time periods based on the likely content of those social media posts.

The example profile analyzer 344 of the expiration monitor 340 of FIG. 3 to analyze the social media profile and/or user account associated with the social media profile to which the social media post was added. The example profile analyzer may determine characteristics of a subscriber associated with the social media profile based on information from the social media profile or user account. For example, the status analyzer 344 may determine age, relationship information, work/employment associated information, geographical information, etc. associated with a subscriber of the social media profile or user account. The expiration analyzer 340 may use the information determined by the profile analyzer 344 to set an expiration time for a social media post. For example, the profile analyzer 344 may determine that the subscriber works or has worked for a particular company. Based on the fact that the user works for a particular company, and the post analyzer 320 detects content regarding the particular company, the example expiration analyzer 344 may determine an appropriate expiration time for the particular company.

In some examples, the expiration monitor 140 may analyze any social media posts associated with a particular social media profile (e.g., by scanning a history or timeline of social media posts). In such examples, the expiration monitor 140 may instruct the profile analyzer 344 to monitor a social media profile for updates to the social media profile. When the profile analyzer 344 determines that a social media profile has been updated, the expiration monitor 140 may instruct the post analyzer 320 to analyze any posts uploaded to the social media profile to determine whether the social media posts are associated with the update to the social media profile. For example, if a subscriber updates a social media profile to indicate having a new employer (i.e., started a new job), the expiration monitor 140 may instruct the post analyzer 320 to analyze social media posts to identify any social posts referencing the new employer. If the post analyzer 320 detects a social media post referencing the new employer, the expiration monitor 140 may instruct the expiration analyzer 340 to update an expiration time or expiration time period associated with the social media post.

The expiration analyzer 340 of FIG. 3 may use the status analyzer 346 to determine a status of a subscriber associated with the monitor social media profile or user account. For example, the status analyzer 346 may determine a location of the subscriber of the social media profile. In such an example, the status analyzer 346 may retrieve geo-location information from the user device 110 (e.g., from a global positioning system (GPS), a location of an access point in communication with the user device, etc.) and/or identify geographic location information from other social media posts identifying the subscriber (e.g., when the subscriber is “checked-in” at a location). The expiration analyzer 340 may use the geographic location information determined by the status analyzer 346 to set the expiration time of the social media posts. For example, if the geographic location corresponds to a location of a bar or pub, the expiration analyzer 340 may determine that the expiration time should be different than if the geographic location corresponds to a location of a library.

In some examples, the status analyzer 346 of FIG. 3 may be used to determine an availability of a subscriber associated with a social media profile. For example, a user may set an availability and/or an availability schedule. Based on the determined availability of the subscriber, the expiration analyzer 340 may set the expiration time. For example, if the subscriber is determined to be unavailable (e.g., based on an indication in the profile or in another social media post), the expiration analyzer 340 may set an expiration time for a social media post differently than if the subscriber is available. In such an example, the subscriber may desire the expiration time to be longer so that the subscriber would be able to access the social media post when available. In some examples, the subscriber may wish to set an expiration time period (perhaps depending on a determined classification categories) such that a social media post is not accessible until the subscriber is available.

While an example manner of implementing the expiration monitor 140 of FIGS. 1A and/or 1B is illustrated in FIGS. 2 and/or 3, at least one of the elements, processes and/or devices illustrated in FIGS. 2 and/or 3 may be combined, divided, re-arranged, omitted, eliminated and/or implemented in any other way. Further, the post analyzer 220, the expiration analyzer 240, the post monitor 310, the post analyzer 320, the expiration interface 330, the expiration analyzer 340, including the time analyzer 342, the profile analyzer 344, and/or the status analyzer 346 of FIG. 3, and/or, more generally, the example expiration monitor 140 of FIGS. 2 and/or 3 may be implemented by hardware, software, firmware and/or any combination of hardware, software and/or firmware. Thus, for example, any of the post analyzer 220 and/or the expiration analyzer 240 of FIG. 2 and/or the post monitor 310, the post analyzer 320, the expiration interface 330, the expiration analyzer 340, including the time analyzer 342, the profile analyzer 344, and/or the status analyzer 346 of FIG. 3 and/or, more generally, the example expiration monitor 140 of FIGS. 2 and/or 3 could be implemented by at least one analog or digital circuit(s), logic circuits, programmable processor(s), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the post analyzer 220 and/or expiration 240 of FIG. 2 or the post monitor 310, the post analyzer 320, the expiration interface 330, and/or the expiration analyzer 340, including the time analyzer 342, the profile analyzer 344, and/or the status analyzer 346 of FIG. 3 is/are hereby expressly defined to include a tangible computer readable storage device or storage disk such as a memory, a digital versatile disk (DVD), a compact disk (CD), a Blu-ray disk, etc. storing the software and/or firmware. Further still, the example expiration monitor 140 of FIG. 2 may include at least one elements, processes and/or devices in addition to, or instead of, those illustrated in FIG. 3, and/or may include more than one of any or all of the illustrated elements, processes and devices.

As disclosed herein, the expiration analyzer 240, 340 of FIGS. 2 and/or 3 analyzes many factors to determine and set an expiration time or expiration time period for an analyzed social media post. As an example, the expiration analyzer 240, 340 may use an expiration time table, such as the example expiration time table 400 illustrated in FIG. 4. Examples of social media posts are included in an example post column 401. For the example posts in the example post column 301, the example expiration time table 400 includes a content type column 420, a category identifier column 430 and an expiration time column 440.

In the illustrated example of FIG. 4, the example social media posts in the example post column 401 may be at least one of a text post (e.g., a message, a comment, a “status” on a Facebook® page, a “tweet” on a Twitter® page, etc.), an image, a video, an audio clip, an article (e.g., from an online news outlet, from an online magazine, from a website, from a weblog, etc.) or any other type of social media post. The example social media posts in the example post column 401 indicate content and/or at least one characteristic of the social media post that may indicate a particular corresponding content type in the content type column 420 and/or corresponding category in the category identifier column 430. The example expiration time column 440 indicates an expiration time for the content type and/or category identifier indicated in the content type 420 and category identifier column 430, respectively. In some examples, a user and/or subscriber may adjust and/or change the expiration times in the expiration column 440, edit or change the content types in the content type column 420, and/or edit or change the category identifier in the category identifier column 430.

In some examples, a content type may not correspond to a particular category identifier as illustrated in the example of FIG. 4. For example, with reference to the expiration time table 400 of FIG. 4, category rows may be added to the expiration time table that do not correspond to a particular content type, but are based on at least one characteristic of a social media post (e.g., a time of the post, a location associated with the social media post, etc.). Such example categories may have different designated expiration times for social media posts satisfying rules associated with a particular category as categories corresponding to an analyzed content type.

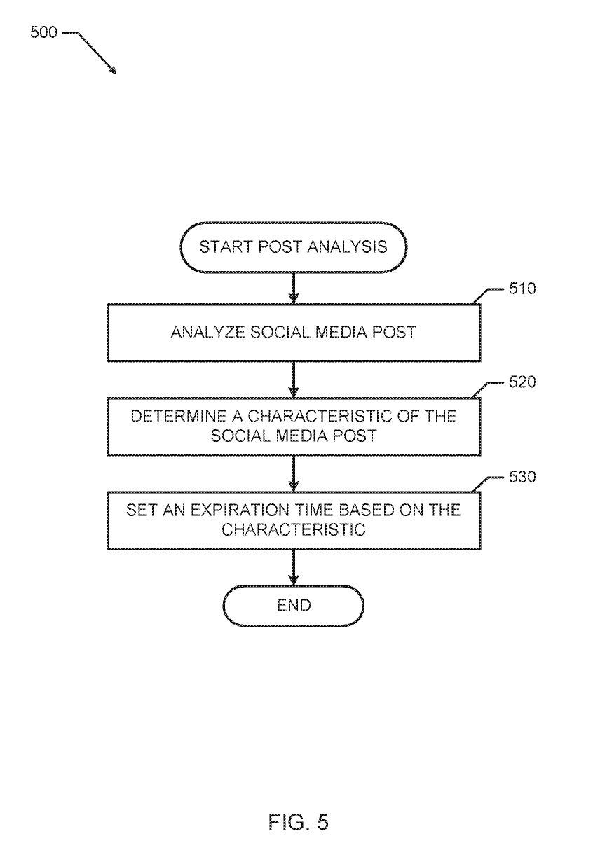

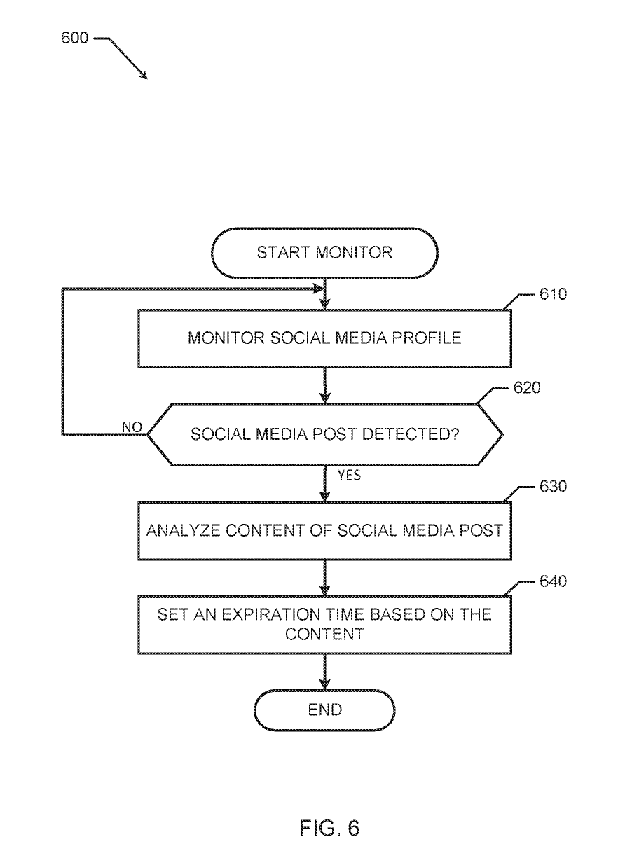

Flowcharts representative of example machine readable instructions for implementing the expiration monitor 140 of FIGS. 2 and/or 3 are shown in FIGS. 5, 6, and/or 7. In this example, the machine readable instructions comprise a program for execution by a processor such as the processor 812 shown in the example processor platform 800 discussed below in connection with FIG. 8. The programs may be embodied in software stored on a tangible computer readable storage medium such as a CD-ROM, a floppy disk, a hard drive, a digital versatile disk (DVD), a Blu-ray disk, or a memory associated with the processor 812, but the entire program and/or parts thereof could alternatively be executed by a device other than the processor 812 and/or embodied in firmware or dedicated hardware. Further, although the example programs are described with reference to the flowcharts illustrated in FIGS. 5, 6, and/or 7, many other methods of implementing the example expiration monitor 140 of FIGS. 2 and/or 3 may alternatively be used. For example, the order of execution of the blocks may be changed, and/or some of the blocks described may be changed, eliminated, or combined.

The program 500 of FIG. 5 begins with an initiation of the expiration monitor 140 of FIGS. 2 and/or 3 (e.g., in response to detecting a social media post, in response to identifying a social media profile to be analyzed, etc.). The example program 500 is executed to analyze a social media post. In some examples, the program 500 may be iteratively executed to implement the expiration monitor 140 to analyze a plurality of social media posts and/or social media profiles.

At block 510 of the illustrated example of FIG. 5, the example post analyzer 220, 320 of FIGS. 2 and/or 3 analyzes a social media post. Accordingly, at block 510, the post analyzer receives and/or retrieves content from the social media post and performs a classification analysis of the content. Based on the classification analysis, at block 510 the post analyzer 220, 320 assigns a classification category to the social media post. At block 520, the example expiration analyzer 240, 340 determines a characteristic of the social media post. As disclosed herein, the expiration analyzer 240, 340 may determine the classification category of the social media post, an example time associated with the social media post, an example location associated with the social media post, etc. In some examples, at block 520, the example expiration analyzer 240, 340 determines a characteristic of the social media post in conjunction with a profile setting and/or status of a subscriber associated with the social media profile. In some examples, the characteristic determined at block 520 is based on information associated with a social media profile and/or a status of a subscriber associated with a social media profile.

At block 530, the example expiration analyzer 240, 340 sets an expiration time and/or expiration time period based on the characteristic. In some examples, at block 530, the example expiration analyzer 240, 340 cross-references the characteristic of the social media post (e.g., a content category, a post time, a location, a subscriber, etc.) to an expiration time table (e.g., the expiration time table 300 of FIG. 3). As disclosed herein, the expiration time set in block 530 designates a time at which the social media post analyzed at block 510 is to no longer be accessible from the social media profile (e.g., the social media post is removed from the social media profile and/or the social network server 130). After block 530, the program 500 in the example of FIG. 5 ends.

The program 600 of FIG. 6 begins with an initiation of the expiration monitor 140 of FIGS. 2 and/or 3 (e.g., by executing an expiration monitor application on the user device 110, by installing and/or executing an expiration monitor on the social network server 130, in response to user instructions, etc.). The example program 600 may be executed prior to, after, and/or simultaneously with the program 500 of FIG. 5. At block 610, the expiration monitor 140 monitors a social media profile.

At block 620, the post monitor 310 of the expiration monitor 140 detects whether a social media post has been uploaded and/or added to a social media profile. As disclosed herein, at block 620, the post monitor 310 may detect a social media post by monitoring communications (e.g., notifications, posts, etc.) via the user device 110 and/or the social network server 130. If the post monitor 310 does not detect a social media post to a social media profile, control returns to block 610 to continuing monitoring for a social media post. If, at block 620, the post monitor 310 does detect a social media post to a social media profile, control advances to block 630.

At block 630, the post analyzer 220, 320 analyzes content of the detected social media post. In some examples, block 630 may be implemented by executing instructions represented by block 510 of FIG. 5. Accordingly, at block 630, the post analyzer 220, 320 may determine a characteristic, classification category, etc. from the content of the social media post. At block 640, the expiration analyzer 240, 340 sets an expiration time for the social media post based on the analyzed content in block 630. In some examples, block 640 may be implemented by executing instructions represented by block 530 of FIG. 5. Accordingly, after block 640, the expiration monitor 140 has set an expiration time for the social media post detected in block 620 based on the content analyzed in block 630.

After block 640, the program 600 of FIG. 6 ends. In some examples, after block 640, the example expiration monitor 140 may determine whether to continue monitoring a social media profile for social media posts uploaded to the social media profile. If the expiration monitor 140 is to continue monitoring for social media posts, the program 600 begins again. If the expiration monitor 140 is to cease monitoring for social media posts to the social media profile (e.g., due to a shutdown, to termination of an expiration monitor application, etc.), the program 600 ends.

The program 700 of FIG. 7 begins with an initiation of the expiration interface 330 of the expiration monitor 140 (e.g., in response to initiating the expiration monitor 140). The example program 700 may be executed prior to, following, and/or concurrently with the example programs 500, 600 of FIGS. 5 and/or 6, respectively. At block 710, the example expiration interface 330 determines whether an expiration time has been set for a detected social media post (e.g., a social media post detected by the post monitor 310, and/or a social media post detected in the programs 500, 600 of FIGS. 5 and/or 6). For example, the expiration interface 330 may receive a notification form the expiration analyzer 240, 340 of FIGS. 2 and/or 3 after the expiration analyzer 240, 340 assigns an expiration time to a social media post. If an expiration time has not been set for a social media post, control returns to block 710. If at block 710, an expiration time has been set for a social media post, control advances to block 720.

In the example of FIG. 7, at block 720, the expiration interface 330 prompts a user with the set expiration time (e.g., by presenting a dialog box on a display, by audibly announcing the expiration time via a speaker, etc.). At block 730, the expiration interface 330 determines whether the set expiration time has been accepted by the user. If at block 730, the expiration interface determines that the expiration time has been accepted by the user (e.g., the user acknowledges that the expiration time is acceptable by clicking a button, the user does not respond after a designated time period, etc.), control advances to block 480 and no adjustment is made to the classification settings. In some examples, if the expiration time is accepted at block 730, the expiration interface 330 may indicate to the expiration analyzer 240, 340 that the expiration time has been accepted. In such examples, the expiration analyzer 240, 340 may adjust a learning method to reflect that content and/or characteristic(s) of the social media post accurately correspond(s) to a classification and/or category assigned to the social media post. If at block 730, the expiration interface 330 determines that the expiration time has not been accepted by the user, control advances to block 740. For example, the expiration interface 330 may determine that the user rejected the expiration time using a rejection button in the prompt and/or by determining that the user manually adjusted the set expiration time using the expiration time interface 330.

At block 740 of the illustrated example of FIG. 7, the example expiration interface 330 confirms the classification category corresponding to the social media post of block 710. For example, at block 740, the expiration interface 330 may prompt the user to confirm whether the correct classification category was determined for the social media post. At block 750, the expiration interface 330 determines whether the classification category was confirmed. If the classification category is confirmed at block 750 (e.g., the user acknowledges the correct category in the prompt, the user does not indicate that the classification category is incorrect, etc.), control advances to block 770. If the expiration interface 330 determines at block 750 that the classification category is not confirmed, control advances to block 760. At block 760, the expiration analyzer 760 requests and/or retrieves an updated classification category. In some examples, the expiration interface 330 may request a user to indicate a classification category. In some examples, at block 760, the expiration analyzer 330 may request the expiration analyzer 240, 340 to determine another classification category for the social media post.

After block 750 and/or block 760 of FIG. 7, the expiration analyzer 240, 340 adjusts classification settings based on an adjusted expiration time for the social media post of block 710 and a corresponding classification category. Accordingly, at block 770, the expiration analyzer 470, using machine learning methods, may adjust an expiration time for classification category of the social media post. For example, the if the classification category for the social media post was determined to be work related (e.g., whether correctly by the expiration analyzer 240, 340 and/or as indicated by the user), the expiration analyzer may change the expiration time for work related social media posts to a same or similar time as the expiration time set for the social media post. In some examples, at block 770, the expiration analyzer may shorten or lengthen an expiration time or expiration time for a determined classification period based on the adjusted expiration time.

At block 780 of the illustrated example of FIG. 7, the example expiration monitor 140 determines whether to continue monitoring for feedback user feedback. If the expiration monitor 140 is to continue monitoring for user feedback, control returns to block 710. If, at block 780, the expiration monitor 140 determines that it is not to continue monitoring for user feedback (e.g., due to instructions from a user, due to shutdown of the expiration monitor, etc.), the program 700 ends.

As mentioned above, the example processes of FIGS. 5, 6, and/or 7 may be implemented using coded instructions (e.g., computer and/or machine readable instructions) stored on a tangible computer readable storage medium such as a hard disk drive, a flash memory, a read-only memory (ROM), a compact disk (CD), a digital versatile disk (DVD), a cache, a random-access memory (RAM) and/or any other storage device or storage disk in which information is stored for any duration (e.g., for extended time periods, permanently, for brief instances, for temporarily buffering, and/or for caching of the information). As used herein, the term tangible computer readable storage medium is expressly defined to include any type of computer readable storage device and/or storage disk and to exclude propagating signals and to exclude transmission media. As used herein, “tangible computer readable storage medium” and “tangible machine readable storage medium” are used interchangeably. Additionally or alternatively, the example processes of FIGS. 5, 6, and/or 7 may be implemented using coded instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media. As used herein, when the phrase at least is used as the transition term in a preamble of a claim, it is open-ended in the same manner as the term “comprising” is open ended.

FIG. 8 is a block diagram of an example processor platform 800 capable of executing the instructions of FIGS. 5, 6, and/or 7 to implement the expiration monitor 140 of FIGS. 2 and/or 3. The processor platform 800 can be, for example, a server (e.g., the social network server 130 of FIG. 1), a personal computer, a mobile device (e.g., a cell phone, a smart phone, a tablet such as an iPad™), a personal digital assistant (FDA), an Internet appliance, a DVD player, a CD player, a digital video recorder, a Blu-ray player, a gaming console, a set top box, or any other type of computing device (e.g., the user device 110 of FIG. 1).

The processor platform 800 of the illustrated example of FIG. 8 includes a processor 812. The processor 812 of the illustrated example is hardware. For example, the processor 812 can be implemented by at least one integrated circuits, logic circuits, microprocessors or controllers from any desired family or manufacturer.

The processor 812 of the illustrated example includes a local memory 813 (e.g., a cache). The processor 812 of the illustrated example is in communication with a main memory including a volatile memory 814 and a non-volatile memory 816 via a bus 818. The volatile memory 814 may be implemented by Synchronous Dynamic Random Access Memory (SDRAM), Dynamic Random Access Memory (DRAM), RAM BUS Dynamic Random Access Memory (RDRAM) and/or any other type of random access memory device. The non-volatile memory 816 may be implemented by flash memory and/or any other desired type of memory device. Access to the main memory 814, 816 may be controlled by a memory controller.

The processor platform 800 of the illustrated example also includes an interface circuit 820. The interface circuit 820 may be implemented by any type of interface standard, such as an Ethernet interface, a universal serial bus (USB), and/or a PCI express interface.

In the illustrated example, at least one input devices 822 are connected to the interface circuit 820. The input device(s) 822 permit(s) a user to enter data and commands into the processor 812. The input device(s) can be implemented by, for example, an audio sensor, a microphone, a camera (still or video), a keyboard, a button, a mouse, a touchscreen, a track-pad, a trackball, isopoint and/or a voice recognition system.

At least one output device(s) 824 are also connected to the interface circuit 820 of the illustrated example. The output devices 824 can be implemented, for example, by display devices (e.g., a light emitting diode (LED), an organic light emitting diode (OLED), a liquid crystal display, a cathode ray tube display (CRT), a touchscreen, a tactile output device, a light emitting diode (LED), a printer and/or speakers). The interface circuit 820 of the illustrated example, thus, typically includes a graphics driver card, a graphics driver chip or a graphics driver processor.

The interface circuit 820 of the illustrated example also includes a communication device such as a transmitter, a receiver, a transceiver, a modem and/or network interface card to facilitate exchange of data with external machines (e.g., computing devices of any kind) via a network 826 (e.g., an Ethernet connection, a digital subscriber line (DSL), a telephone line, coaxial cable, a cellular telephone system, etc.).

The processor platform 800 of the illustrated example also includes at least one mass storage devices 828 for storing software and/or data. Examples of such mass storage devices 828 include floppy disk drives, hard drive disks, compact disk drives, Blu-ray disk drives, RAID systems, and digital versatile disk (DVD) drives.

The expiration monitor coded instructions 832 of FIGS. 5, 6, and/or 7 may be stored in the mass storage device 828, in the local memory 813 in the volatile memory 814, in the non-volatile memory 816, and/or on a removable tangible computer readable storage medium such as a CD or DVD to implement the expiration monitor 140 when executed.

From the foregoing, it will be appreciated that the above disclosed methods, apparatus and articles of manufacture provide for automatically setting an expiration time or expiration time period of a social media post, such that the social media post may no longer be accessed and/or viewed on a social media profile after the expiration time or expiration time period. Accordingly, examples disclosed herein, allow for a user to upload social media posts and/or receive social posts from other subscribers of the social network without having the social media posts accessible from the subscriber's social media profile for an indefinite period of time. Examples herein allow for an example expiration monitor to learn user preferences for setting expiration times for social media posts based on the expiration times for social media posts having similar characteristics and/or content. Accordingly, using the examples disclosed herein, if a user wishes to remove a social media post having certain characteristics or content, the user may not have to manually remove or delete certain social media posts from a social media profile.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

What is claimed is:

1. A method comprising:
analyzing a social media post on a social media profile;
determining a first characteristic of the social media post; and
setting an expiration time at which the social media post is to be removed from the social network interface based on the first characteristic.

2. The method as defined in claim 1, further comprising:
identifying a user account associated with the social media post;
determining a first setting from the user account; and
determining the first characteristic of the social media post based on the first setting.

3. The method as defined in claim 1, further comprising:
classifying the social media post into at least one category of a plurality of categories, the first characteristic being defined by the at least one category.

4. The method as defined in claim 1, wherein the first characteristic is defined by a classification category and a setting of a user profile associated with the social media post.

5. The method as defined in claim 1, wherein the social media post is posted by a user corresponding to the social media profile.

6. The method as defined in claim 1, wherein a first user posts the social media post to the social media profile and the social media profile is registered to a second user.

7. The method as defined in claim 1, further comprising presenting the expiration time to a user registered to the social media profile.

8. The method as defined in claim 7, further comprising monitoring feedback from the user, the feedback determined based on whether the user changes the expiration time to a different expiration time; and
adjusting a classification setting for determining the first characteristic based on the feedback.

9. An apparatus comprising:
a post analyzer to analyze a social media post on a social media profile and classify the social media post into a classification category; and
an expiration analyzer to set an expiration time for the social media post based on the classification category, the expiration time comprising a time that the social media post is to be removed from the social media profile.

10. The apparatus as defined in claim 9, further comprising:
a post monitor to detect the social media post.

11. The apparatus as defined in claim 9, further comprising:
an expiration interface to present the expiration time to a user registered to the social media profile.

12. The apparatus as defined in claim 11, wherein the expiration interface is further to provide classification settings to the post analyzer based on a user response.

13. The apparatus as defined in claim 12, wherein the user response comprises a change to the expiration time presented by the expiration interface.

14. A non-transitory computer readable storage medium comprising instructions that, when executed, cause a machine to at least;
monitor a social media profile of a user;
detect a social media post in the social media profile;
analyze content of the social media post; and
set an expiration time for the social media post based on the content.

15. The non-transitory computer readable storage medium as defined in claim 14, wherein the instructions, when executed, further cause the machine to:
reference a characteristic of the social media profile based on the content;
classify the content into a category based on the content and the characteristic; and
cross-reference the category to an expiration time table to determine the expiration time.
